(19) United States
(12) Patent Application Publication
(10) Pub. No.: US 2005/0283983 A1
(43) Pub. Date: Dec. 29, 2005

(54) Knife having automatically loading blade

(76) Inventor: Yin Han Huang, Taichung (TW)

Correspondence Address: Yin Han Huang, P.O. Box 63-99, Taichung, 406, TW

(21) Appl. No.: 10/874,882

(22) Filed: Jun. 23, 2004

(51) Int. Cl. B26B 1/00

(52) U.S. Cl. 30/162

(57) ABSTRACT

A utility knife includes a handle having a passage to slidably receive a blade carrier which has a space to receive a knife blade and to move the knife blade into or out of the handle. The blade carrier includes a spring limb having a latch to engage with and to anchor the knife blade to the blade carrier. An actuator device may selectively disengage the latch of the spring limb from the knife blade, to release the knife blade from the blade carrier. One or more spare blades may be received in the handle, and one spare blade may be biased into the space of the blade carrier when the blade carrier is moved into the handle and when the space of the blade carrier is emptied.

### BACKGROUND OF THE INVENTION

1. Field of the Invention

The present invention relates to a utility knife, and more particularly to a utility knife having a knife blade loading structure to load the knife blades automatically.

2. Description of the Prior Art

Various kinds of typical utility knives have been developed and comprise a blade carrier slidably received in a handle or a housing, to carry a knife blade, and to move the knife blade into and out of the housing between an outwardly working position and an inwardly receiving or storing position.

For example, U.S. Pat. No. 6,163,963 to Huang, and U.S. Pat. No. 6,243,953 to Huang disclose two of the typical utility knives each also comprising a blade carrier slidably received in a housing to carry and to move the knife blade into and out of the housing.

Normally, the typical utility knives comprise two housing members secured together, before the blade carrier slidably engaged into and received in the housing. However, after the knife blades have been worn out or damaged, it is required to separate the two housing members away from each other, for allowing the knife blades to be replaced with the other ones.

In these kinds of utility knives, the knife blades may not be easily and quickly replaced with the other ones without disengaging or disassembling the two housing members away from each other, such that the knife blades may not be easily and quickly replaced with the other new ones.

U.S. Pat. No. 6,249,975 to Lin discloses another typical utility knife comprising a blade support slidably received in a housing to carry and to move the knife blade into and out of the housing, and further comprising a button slidably received in the housing, to selectively disengage the knife blade from the blade support, and to allow the knife blades to be disengaged or removed from the housing. However, it will be difficult to engage a new knife blade into the blade support and the housing.

U.S. Pat. No. 5,966,817 to Lee, and U.S. Pat. No. 6,192,589 to Martone et al. disclose two different typical utility knives each also comprising a blade carrier slidably received in a housing to carry and to move the knife blade into and out of the housing, and further comprising a storage casing to receive spare blades.

However, after the knife blades have been worn out or damaged, it is also required to separate the two housing members away from each other, or to rotate or move the casing away from the housing, to remove the spare blades from the casing, and to allow the knife blades to be replaced with the other ones.

U.S. Pat. No. 5,727,320 to Shepherd et al. discloses another typical utility knife comprising a blade carrier slidably received in a housing to carry and to move the knife blade into and out of the housing, and further comprising a blade magazine to receive spare blades.

However, after the knife blades have been worn out or damaged and when it is required to change the knife blades, the blade carrier is required to be retracted backwardly, to move the worn out or damaged knife blade into the blade magazine, and then to rotate the blade magazine relative to the housing, to allow the spare blade to be changeably attached into the blade carrier. The blade magazine includes a complicated configuration.

In addition, only one end of the knife blade may be used. For changing the knife blades to the other ends, the blade magazine is required to be disassembled from the housing, in order to change the knife blades. Accordingly, it will also be difficult to change or to replace the knife blades with the other ones.

U.S. Pat. No. 4,517,741 to Castelluzzo discloses a further typical utility knife comprising a handle having a cavity formed therein to receive a stack of the blades, a slide having a magnetic face for engaging and sliding the innermost blade into extended position and for retracting the blade into the handle, and a lock is further required to be provided for locking the blade extended.

However, the magnetic face of the slide may not stably hold or secure the blade thereto, such that an additional lock is further required to lock the blade extended, and such that the users have to operate the lock to release or to lock the blade to the handle.

The present invention has arisen to mitigate and/or obviate the afore-described disadvantages of the conventional utility knives.

### SUMMARY OF THE INVENTION

The primary objective of the present invention is to provide a utility knife including a knife blade loading structure to load the knife blades automatically.

The other objective of the present invention is to provide a utility knife including an actuator device to easily and quickly remove knife blade from the handle without dismantling or disassembling the handle.

In accordance with one aspect of the invention, there is provided a utility knife comprising a handle including a passage formed therein and having an open front formed therein, the handle including a chamber formed therein and communicating with the passage thereof, a blade carrier slidably received in the passage of the handle, and including a space formed therein, to receive a knife blade therein, the blade carrier being movable forwardly and rearwardly relative to the handle to move the knife blade either into the handle at a storing position, or out through the open front of the handle to an outwardly extending working position, the blade carrier including a spring limb having a latch extended therefrom, to engage with the knife blade, and to anchor the knife blade to the blade carrier, and to allow the knife blade to be moved relative to the handle by the blade carrier, a disengaging device for selectively disengaging the latch of the spring limb from the knife blade, to release the knife blade from the blade carrier and the handle, and to allow the knife blade to be disengaged from the blade carrier and the handle, at least one spare blade received in the chamber of the handle, and aligned with the space of the blade carrier when the blade carrier is moved into the handle, and a spring biasing device for biasing the spare blade into the space of the blade carrier when the blade carrier is moved into the handle and when the space of the blade carrier is emptied.

The handle includes a peg extended into the chamber thereof, and the biasing device includes a spring member having an aperture formed therein to receive the peg, and to attach the spring member to the handle, the spring member is engaged with the spare blade, to bias the spare blade toward the blade carrier.

The handle includes an opening formed therein and communicating with the passage and the chamber thereof, to receive the spare blade, and to allow the spare blade to be engaged into the chamber of the handle.

The handle includes a cover slidably engaged in the opening of the handle, to enclose the opening of the handle. The handle includes at least one channel formed therein, the cover includes at least one rib slidably engaged in the channel of the handle, to slidably attach the cover to the handle.

The cover includes a fence extended therefrom, to engage with and to move the spare blade into the chamber of the handle. The fence of the cover includes at least one recess formed therein. The handle includes at least one projection extended therefrom, to engage into the handle, and to releaseably secure the cover to the handle.

The disengaging device includes an actuator device slidably engaged in the handle, and engageable with the spring limb, to selectively disengage the latch of the spring limb from the knife blade, and to release the knife blade from the blade carrier and the handle.

The spring limb includes an ear extended therefrom, and aligned with the actuator device, for being selectively depressed by the actuator device. The disengaging device includes a biasing device for biasing the actuator device away from the ear of the spring limb.

The handle includes a cavity formed therein, to selectively receive the latch of the spring limb. The knife blade and the spare blade each includes at least one notch formed therein, to receive the latch of the spring limb, and to selectively anchor the knife blade and the spare blade to the blade carrier.

The handle includes at least one depression formed therein, the blade carrier includes a resilient arm extended upwardly therefrom, and having a catch provided thereon, to selectively engage into the depression of the handle, and to position the blade carrier to the handle at selected position.

The blade carrier includes a knob attached to the resilient arm, and slidably extended out through the handle, to move the blade carrier forwardly and rearwardly relative to the handle.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a utility knife in accordance with the present invention;

FIG. 2 is a perspective view of the utility knife;

FIG. 3 is a side plan view of the utility knife, in which one half of the handle is removed to show an inner structure of the utility knife;

FIGS. 4, 5 are side plan views similar to FIG. 3, illustrating the operation of the utility knife;

FIG. 6 is a side plan view showing a blade carrier of the utility knife for carrying and moving the knife blade;

FIG. 7 is a partial cross sectional view of the blade carrier, taken along lines 7-7 of FIG. 6;

FIG. 8 is a partial cross sectional view similar to FIG. 7, illustrating the operation of the blade carrier of the utility knife;

FIG. 9 is a perspective view similar to FIG. 2, illustrating the operation of the utility knife;

FIG. 10 is a cross sectional view of the blade carrier, taken along lines 10-10 of FIG. 9;

FIG. 11 is a cross sectional view similar to FIG. 10, illustrating the operation of the actuator device of the utility knife;

FIG. 12 is a partial exploded view, illustrating the disengagement of the knife blade from the handle of the utility knife;

FIG. 13 is a partial exploded view, illustrating the engagement of the spare knife blades into the handle of the utility knife; and

FIG. 14 is a cross sectional view taken along lines 12-12 of FIG. 12.

### DETAILED DESCRIPTION OF THE PREFERRED EMBODIMENT

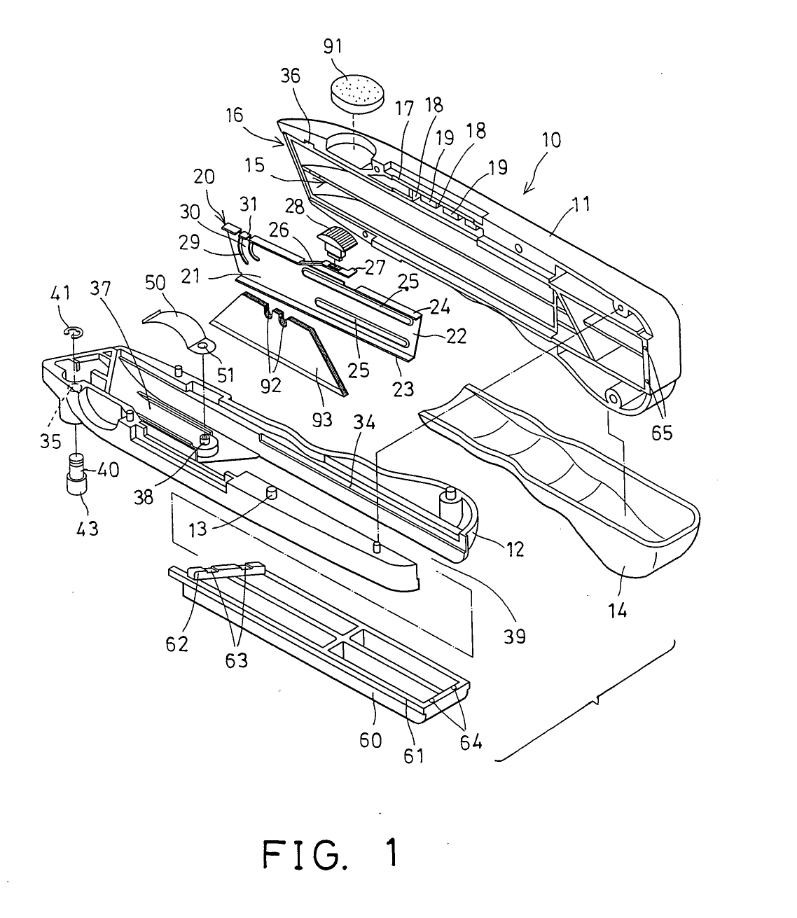

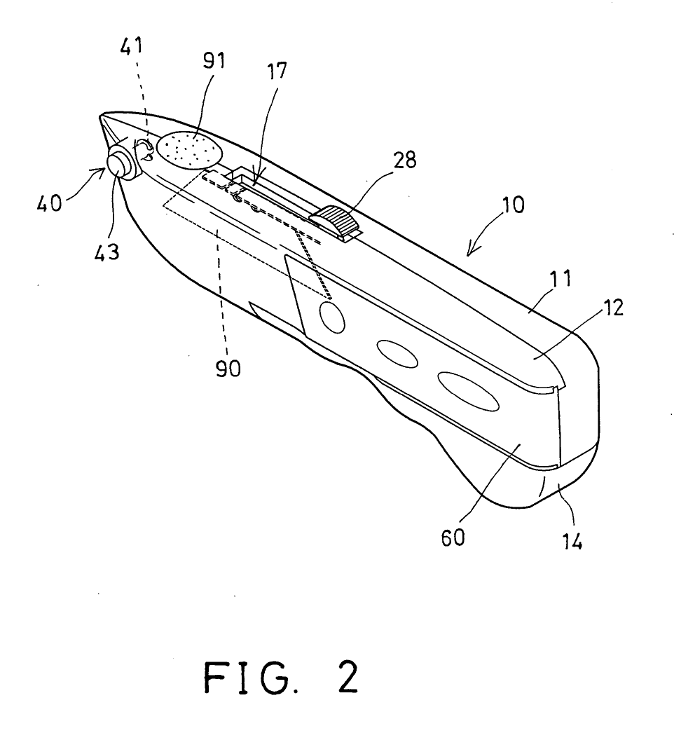

Referring to the drawings, and initially to FIGS. 1-4, a utility knife in accordance with the present invention comprises a handle 10 including such as two handle members 11, 12 secured together by adhesive materials, fasteners (not shown), or by welding processes. For example, one of the handle members 12 may include one or more juts 13 extended therefrom, and engaged into the other handle member 11, before the handle members 11, 12 are welded or secured together, for allowing the handle members 11, 12 to be solidly secured together.

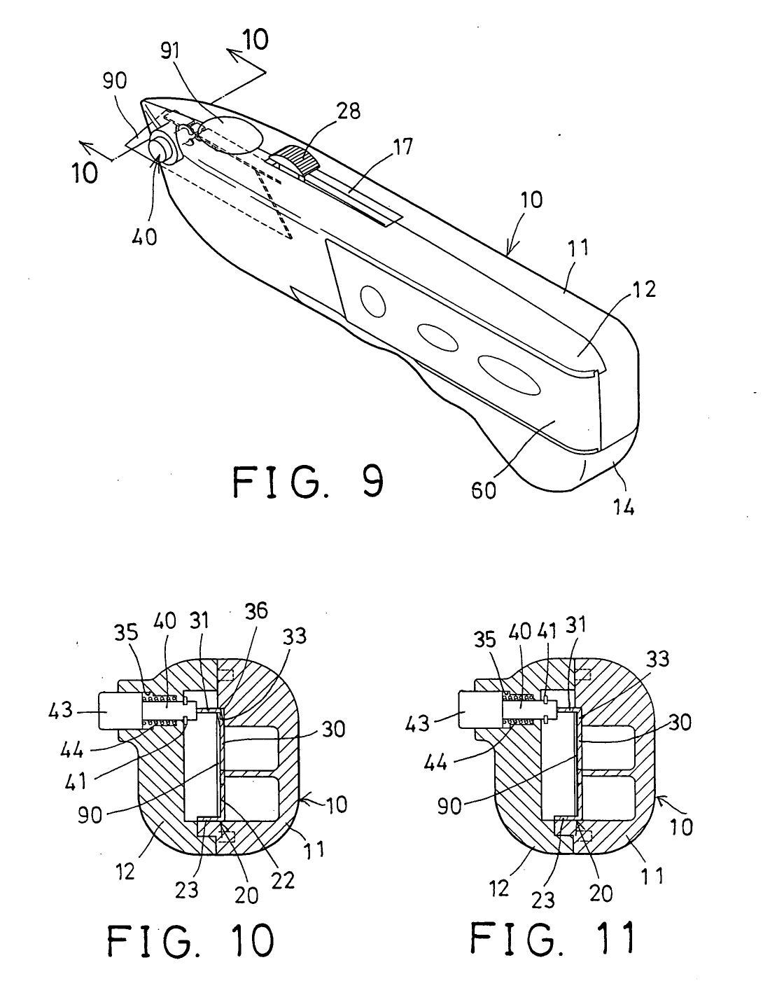

The handle 10 includes a conventional passage 15 formed therein and having an open front 16 formed therein, for allowing a knife blade 90 to be slidably extended out through the open front 16 of the handle 10 to an outwardly extending working position (FIGS. 4, 9). A soft covering 14 may be attached to the lower portion of the handle 10, to allow the users to comfortably hold or grasp the handle 10. A pad 91 may be disposed in the front and upper portion of the handle 10, to allow the users to comfortably operate the utility knife by depressing the pad 91.

The handle 10 includes a groove 17 formed in the middle and upper portion thereof, and one or more depressions 18 also formed in the middle and upper portion thereof, and communicating with the groove 17 thereof, and defined by one or more protrusions 19. The grooves 17 and the depressions 18 of the handle 10 are also communicating with the passage 15 of the handle 10.

A blade carrier 20 is slidably received and engaged in the passage 15 of the handle 10, and includes a space 21 formed therein, and defined by a base plate 22, a lower flange 23, and an upper flange 24, to receive a knife blade 90. The blade carrier 20 is movable forwardly and rearwardly relative to the handle 10, in order to either move the knife blade 90 into the handle 10 to a storing position, or out through the open front 16 of the handle 10 to the outwardly extending working position.

The blade carrier 20 includes a spring or resilient arm 26 extended upwardly therefrom, such as extended from the base plate 22 or the upper flange 24, and having a catch 27 formed or provided on the free end thereof, to selectively engage into either of the depressions 18 of the handle 10, and thus to position the blade carrier 20 to the handle 10 at selected position. A knob 28 is attached to the resilient arm 26, and slidably extended out through the groove 17 of the handle 10, to move the blade carrier 20 forwardly and rearwardly relative to the handle 10.

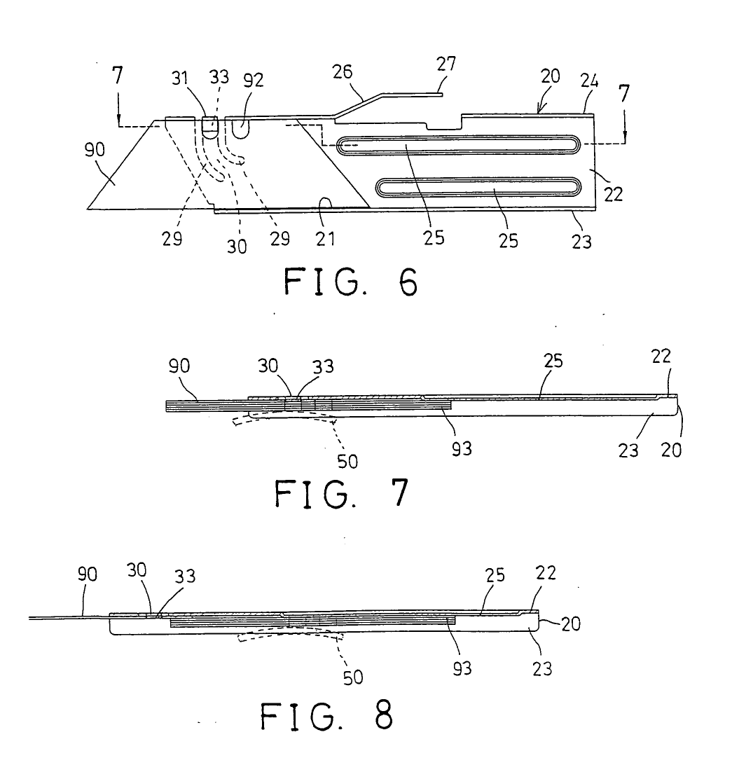

The blade carrier 20 further includes one or more, such as two slots 29 formed in the front portion thereof, to form or define a spring limb 30 which may be engaged with either of the notches 92 of the knife blade 90 (FIGS. 6, 12), to catch or to retain or to anchor the knife blade 90 to the blade carrier 20. The above-identified structure of the handle 10 and the blade carrier 20 is typical and will not be described in further details.

In the present invention, the spring limb 30 of the blade carrier 20 further includes an ear 31 extended or bent from the upper portion of the spring limb 30, and further includes a bent segment or latch 33 (FIGS. 6, 10) extended or bent from the upper portion of the spring limb 30, and located below the ear 31, for engaging into either of the notches 92 of the knife blade 90, and to catch or to anchor the knife blade 90 to the blade carrier 20, and thus for allowing the knife blade 90 to be stably moved relative to the handle 10 by the blade carrier 20.

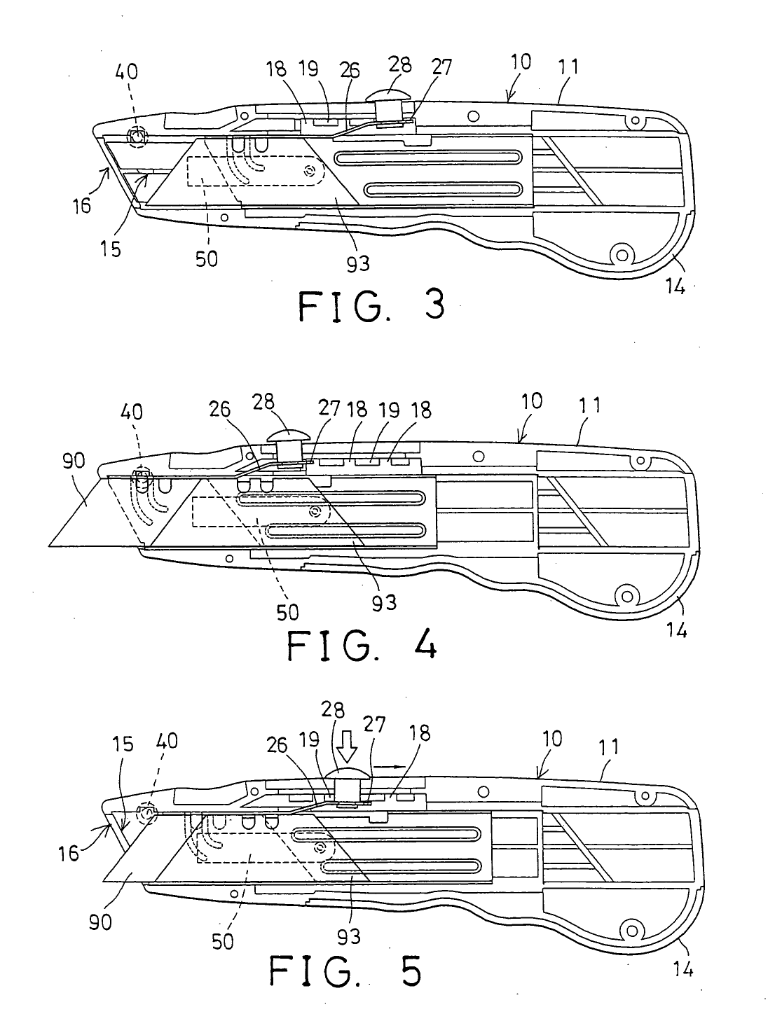

The blade carrier 20 may further include one or more, such as two protuberances 25 extended therefrom, such as extended from the rear portion thereof, to form or define the space 21 thereof, and to further stably engage with the knife blade 90 to the blade carrier 20, and thus for allowing the knife blade 90 to be further stably or effectively moved relative to the handle 10 by the blade carrier 20 (FIGS. 3-8).

As best shown in FIGS. 7 and 8, the protuberances 25 of the blade carrier 20 includes a thickness equals to or slightly smaller than that of one knife blade 90, and the latch 33 of the spring limb 30 may also be engaged into the notch 92 of only one of the knife blades 90, and to allow only one of the knife blades 90 to be stably engaged with and held within the space 21 of the blade carrier 20, and thus to allow the only one knife blade 90 to be moved into and out of the handle 10 by the blade carrier 20 (FIGS. 6-8).

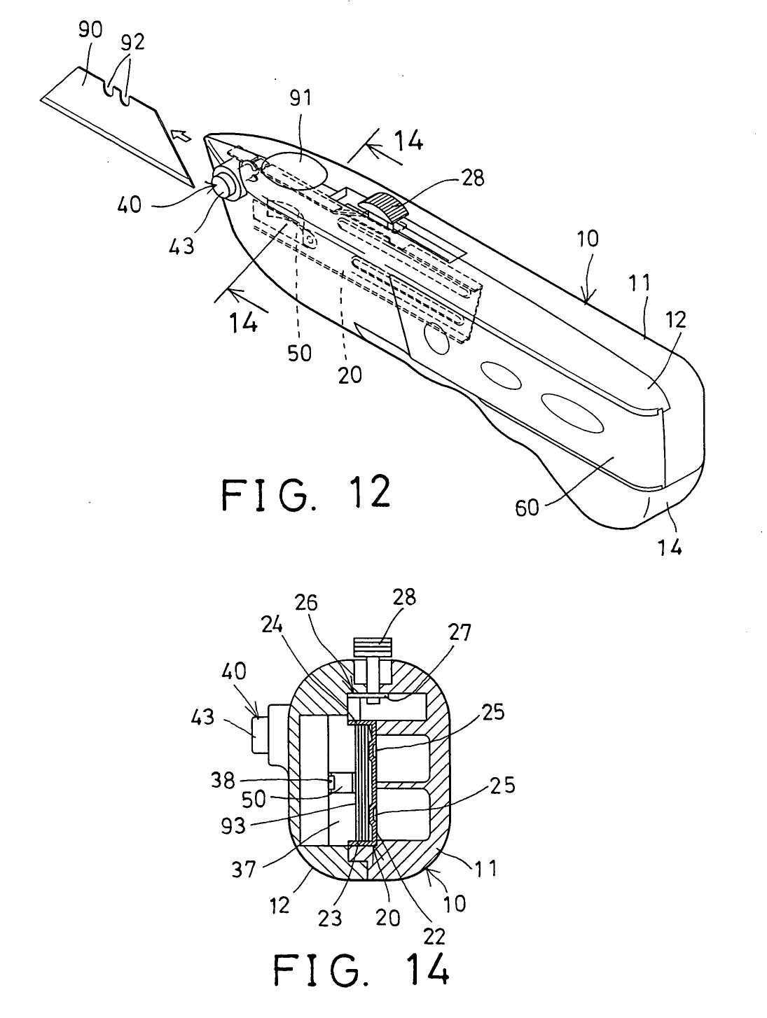

The handle 10 includes an orifice 35 formed in the front portion thereof, such as formed in the handle member 12 (FIG. 1), and a cavity 36 also formed in the front portion thereof, such as formed in the handle member 11 and aligned with the orifice 35 of the handle member 12, for selectively receiving the latch 33 of the spring limb 30 (FIGS. 10, 11), and to allow the latch 33 of the spring limb 30 to be disengaged from the knife blade 90 (FIG. 11), and thus for allowing the knife blade 90 to be disengaged from the blade carrier 20 and the handle 10.

An actuator device 40 is slidably engaged through the orifice 35 of the handle member 12 of the handle 10, and a retaining ring 41 is attached to the actuator device 40 and engageable with the handle member 12 of the handle 10 (FIGS. 10, 11), to slidably and rotatably secure or anchor the actuator device 40 to the handle 10, and to prevent the actuator device 40 from being disengaged from the handle 10. The actuator device 40 may include a button 43 attached to one end and extendible out of the handle 10. A spring 44 may be engaged onto the actuator device 40, and engaged between the actuator device 40 and the handle 10, to bias the actuator device 40 away from the ear 31 of the spring limb 30 (FIG. 10).

As also best shown in FIGS. 10, 11, the actuator device 40 is located and aligned with the ear 31 of the spring limb 30 (FIG. 10), and is movable into the handle 10 against the spring 44, to depress the ear 31 of the spring limb 30, and to selectively force the latch 33 of the spring limb 30 into the cavity 36 of the handle 10 (FIG. 11), and to disengage the latch 33 of the spring limb 30 from the knife blade 90, and thus to release the knife blade 90 from the blade carrier 20 and the handle 10. At this moment, the knife blade 90 may be disengaged from the blade carrier 20 and the handle 10 (FIG. 12).

As shown in FIGS. 1 and 13-14, the handle 10 includes a chamber 37 formed therein and communicating with the passage 15 thereof, to receive one or more spare knife blades 93 therein. It is preferable that the chamber 37 of the handle 10 and the spare knife blades 93 are aligned with the space 21 of the blade carrier 20 when the blade carrier 20 is moved into the handle 10. The handle 10 includes a peg 38 extended into the chamber 37 thereof, and a curved spring member 50 has an aperture 51 formed in one end thereof to receive the peg 38, and to attach the spring member 50 to the handle 10. The spring member 50 is engaged with the spare knife blades 93, to bias or to force the spare knife blades 93 toward the blade carrier 20.

In operation, as shown in FIG. 12, the knife blade 90 may be removed or disengaged from the handle 10 by depressing the actuator device 40 into the handle 10 when the knife blade 90 has been damaged or worn out or required to be changed to the other ones. The space 21 of the blade carrier 20 may thus be emptied. When the blade carrier 20 is moved into the handle 10 with the knob 28 and when the space 21 of the blade carrier 20 is aligned with the spare knife blades 93, the one spare knife blade 93 located nearest the blade carrier 20 may then be biased into the space 21 of the blade carrier 20, and attached to the blade carrier 20 with the latch 33 and/or the protuberances 25.

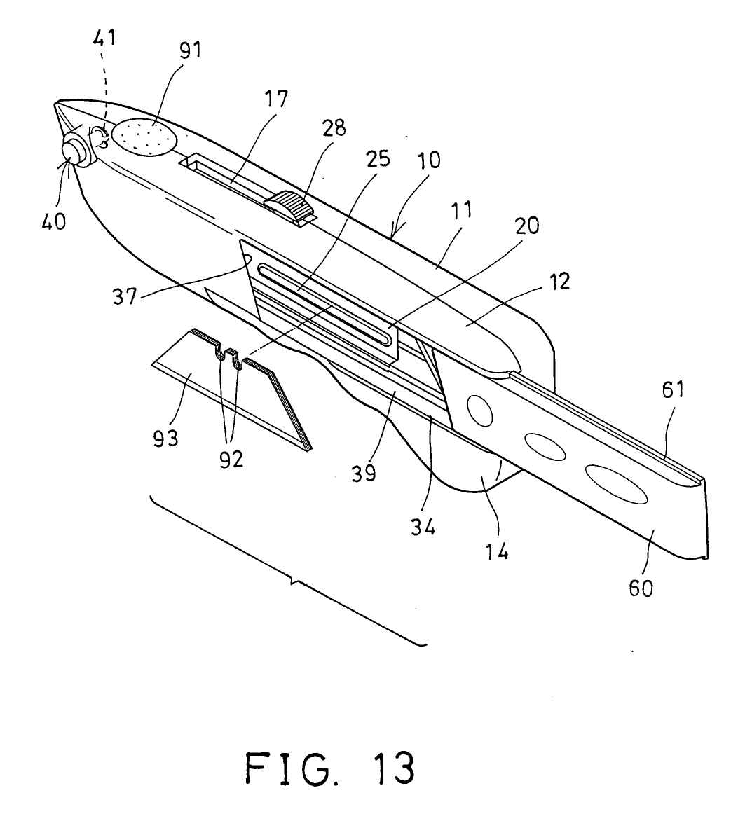

As shown in FIGS. 1 and 13, the handle 10 includes an opening 39 formed therein and communicating with the passage 15 and the chamber 37 thereof, and includes one or two channels 34 formed therein and communicating with the opening 39 thereof. One or more spare knife blades 93 may be engaged into the opening 39 of the handle 10, for engaging into the chamber 37 of the handle 10, and then for being waiting to be biased into the space 21 of the blade carrier 20, and attached to the blade carrier 20.

A cover 60 is slidably engaged in the opening 39 of the handle 10, and includes one or more ribs 61 slidably engaged in the channels 34 of the handle 10, to slidably attach or secure the cover 60 to the handle 10, and to enclose the opening 39 of the handle 10. The cover 60 includes a fence 62 extended therefrom (FIG. 1), for engaging with and for moving the spare knife blades 93 into the chamber 37 of the handle 10. It is preferable that the fence 62 of the cover 60 includes one or more, such as two recesses 63 formed therein to slidably receive the protuberances 25 of the blade carrier 20, and to allow the fence 62 of the cover 60 to effectively move the spare knife blades 93 into the chamber 37 of the handle 10. The cover 60 includes one or more projections 64 extended therefrom (FIG. 1), to engage into corresponding depressions 65 of the handle 10, and to releaseably latch or secure the cover 60 to the handle 10.

It is to be noted that a single knife blade 90 to be carried and moved by a blade carrier 20 is typical, and to be disengaged from the handle 10 is also typical. However, after the space 21 of the blade carrier 20 is emptied, one of the spare knife blades 93 may then be moved or biased into the space 21 of the blade carrier 20 when the blade carrier 20 is moved into the handle 10, such that the spare knife blades 93 may be automatically loaded into the blade carrier 20 without dismantling or disassembling the handle 10. In addition, the spare knife blades 93 may also be easily refilled into the chamber 37 of the handle 10 via the opening 39 of the handle 10, and with the cover 60.

Accordingly, the utility knife includes a knife blade loading structure to load the knife blades automatically, and includes an actuator device to easily and quickly remove knife blade from the handle without dismantling or disassembling the handle.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A utility knife comprising:
a handle including a passage formed therein and having an open front formed therein, said handle including a chamber formed therein and communicating with said passage thereof,
a blade carrier slidably received in said passage of said handle, and including a space formed therein, to receive a knife blade therein, said blade carrier being movable forwardly and rearwardly relative to said handle to move said knife blade either into said handle at a storing position, or out through said open front of said handle to an outwardly extending working position,
said blade carrier including a spring limb having a latch extended therefrom, to engage with said knife blade, and to anchor said knife blade to said blade carrier, and to allow said knife blade to be moved relative to said handle by said blade carrier,
disengaging means for selectively disengaging said latch of said spring limb from said knife blade, to release said knife blade from said blade carrier and said handle, and to allow said knife blade to be disengaged from said blade carrier and said handle,
at least one spare blade received in said chamber of said handle, and aligned with said space of said blade carrier when said blade carrier is moved into said handle, and
means for biasing said at least one spare blade into said space of said blade carrier when said blade carrier is moved into said handle and when said space of said blade carrier is emptied.

2. The utility knife as claimed in claim 1, wherein said handle includes a peg extended into said chamber thereof, and said biasing means includes a spring member having an aperture formed therein to receive said peg, and to attach said spring member to said handle, said spring member is engaged with said at least one spare blade, to bias said at least one spare blade toward said blade carrier.

3. The utility knife as claimed in claim 1, wherein said handle includes an opening formed therein and communicating with said passage and said chamber thereof, to receive said at least one spare blade, and to allow said at least one spare blade to be engaged into said chamber of said handle.

4. The utility knife as claimed in claim 3, wherein said handle includes a cover slidably engaged in said opening of said handle, to enclose said opening of said handle.

5. The utility knife as claimed in claim 4, wherein said handle includes at least one channel formed therein, said cover includes at least one rib slidably engaged in said at least one channel of said handle, to slidably attach said cover to said handle.

6. The utility knife as claimed in claim 4, wherein said handle includes at least one projection extended therefrom, to engage into said handle, and to releaseably secure said cover to said handle.

7. The utility knife as claimed in claim 4, wherein said cover includes a fence extended therefrom, to engage with and to move said at least one spare blade into said chamber of said handle.

8. The utility knife as claimed in claim 7, wherein said fence of said cover includes at least one recess formed therein.

9. The utility knife as claimed in claim 1, wherein said disengaging means includes an actuator device slidably engaged in said handle, and engageable with said spring limb, to selectively disengage said latch of said spring limb from said knife blade, and to release said knife blade from said blade carrier and said handle.

10. The utility knife as claimed in claim 9, wherein said spring limb includes an ear extended therefrom, and aligned with said actuator device, for being selectively depressed by said actuator device.

11. The utility knife as claimed in claim 10, wherein said disengaging means includes means for biasing said actuator device away from said ear of said spring limb.

12. The utility knife as claimed in claim 1, wherein said handle includes a cavity formed therein, to selectively receive said latch of said spring limb.

13. The utility knife as claimed in claim 1, wherein said knife blade and said at least one spare blade each includes at least one notch formed therein, to receive said latch of said spring limb, and to selectively anchor said knife blade and said at least one spare blade to said blade carrier.

14. The utility knife as claimed in claim 1, wherein said handle includes at least one depression formed therein, said blade carrier includes a resilient arm extended upwardly therefrom, and having a catch provided thereon, to selectively engage into said at least one depression of said handle, and to position said blade carrier to said handle at selected position.

15. The utility knife as claimed in claim 14, wherein said blade carrier includes a knob attached to said resilient arm, and slidably extended out through said handle, to move said blade carrier forwardly and rearwardly relative to said handle.
